(19) United States
(12) Patent Application Publication
(10) Pub. No.: US 2018/0040974 A1
(43) Pub. Date: Feb. 8, 2018

(54) ELECTRICAL CONNECTOR

(71) Applicant: LOTES CO., LTD., Keelung (TW)

(72) Inventor: Jian Min Peng, Keelung (TW)

(21) Appl. No.: 15/667,774

(22) Filed: Aug. 3, 2017

(30) Foreign Application Priority Data
Aug. 3, 2016 (CN) 201620829843.7

(51) Int. Cl. H01R 13/52; H01R 4/24; H01R 13/422; H01R 4/02; H01R 13/629

(52) U.S. Cl. CPC H01R 13/5219; H01R 4/02; H01R 13/629; H01R 13/4223; H01R 4/2429; H01R 2107/00

(57) ABSTRACT

An electrical connector, including an insulating body, which is concavely provided with a first filling groove communicating with a groove, and a second filling groove spaced from the first filling groove. Each first terminal has a first connecting portion located partially in the first filling groove, and each second terminal has a second connecting portion located partially in the second filling groove. A metal shell wraps a periphery of the insulating body, and the groove is located between the insulating body and the metal shell. A first sealing member is filled in the first filling groove and extends to fill in the groove. A second sealing member is filled in the second filling groove.

### CROSS-REFERENCE TO RELATED APPLICATIONS

This non-provisional application claims priority to and the benefit of, pursuant to 35 U.S.C. §119(a), Patent Application Serial No. CN201620829843.7 filed in P.R. China on Aug. 3, 2016, the entire content of which is hereby incorporated by reference.

### FIELD OF THE INVENTION

The present invention relates to an electrical connector, and more particularly to an electrical connector with a waterproof function.

### BACKGROUND OF THE INVENTION

The universal serial bus (USB for short) electrical connector is used widely by the public. With the development of electronic products, the transmission speed of the USB electrical connector is becoming higher and higher, while user requirement on the quality of this type of electrical connector is stricter. This type of electrical connector is generally used for mounting on an electronic device, which has an insertion hole for the insertion of an external plug. As a result, the electrical connector may easily contact water to cause short-circuiting, or may be damped and damaged by moisture. Furthermore, moisture can easily infiltrate into the electronic device via the slot to affect circuit boards or other electronic elements in the electronic device, thus reducing the performance of the electronic devices. Industry practitioners may mount a “waterproof plug” on the electrical connector, or mount a “waterproof washer” therein to prevent from the moisture. However, both the waterproof plug and the waterproof washer result in assembly difficulties and high cost. In order to solve these problems, those skilled in the art design a waterproof connector. The waterproof connector includes an insulating body, which is concavely provided with a groove. A first terminal group and a second terminal group are accommodated in the insulating body. The first terminal group is provided with a first soldering portion that passes through a bottom surface of the insulating body, and the second terminal group is provided with a second soldering portion that runs through the bottom surface of the insulating body. In order to prevent crosstalk, a large partitioning area is arranged between the second soldering portion and the first soldering portion. A metal shell wraps a periphery of the insulating body, and the metal shell is provided with multiple guide inlets corresponding to the groove. A first glue dispensing is carried out in the guide inlets, so that glue flows into the groove via the guide inlets to seal the gap between the insulating body and the metal shell. Then, a second glue dispensing is carried out on the bottom surface of the insulating body to seal the first soldering portion and the second soldering portion.

However, the metal shell is provided with the multiple guide inlets, and glue dispensing needs to be carried out for each of the guide inlets. As a result, the glue dispensing processes may be complex, and the usage of glue cannot be accurately controlled. If too much glue is dispensed, the glue can easily overflow to cause waste. If the glue is under-dispensed, sealing may be incomplete and thus resulting in poor sealing. Furthermore, since the partitioning area is arranged between the first soldering portion and the second soldering portion, the glue will flow to the partitioning area when glue is dispensed on the bottom surface of the insulating body. Thus, the glue is also filled in the partitioning area while sealing the first soldering portion and the second soldering portion. As a result, the usage of the glue is increased to cause waste, thereby increasing the manufacturing cost of the electrical connector.

Therefore, a heretofore unaddressed need to design an improved electrical connector exists in the art to address the aforementioned deficiencies and inadequacies.

### SUMMARY OF THE INVENTION

In view of the above problems in the background, one aspect of the present invention is directed to an electrical connector, which is simple in the manufacturing process and saves cost.

To achieve the foregoing objective, one aspect of the invention provides an electrical connector, which includes an insulating body, concavely provided with a groove, a first filling groove communicating with the groove, and a second filling groove spaced from the first filling groove; a plurality of first terminals and a plurality of second terminals, accommodated in the insulating body, wherein each of the first terminals has a first connecting portion located partially in the first filling groove, and each of the second terminals has a second connecting portion located partially in the second filling groove; a metal shell, wrapping a periphery of the insulating body, wherein the groove is located between the insulating body and the metal shell; a first sealing member, filled in the first filling groove and extending to fill in the groove; and a second sealing member, filled in the second filling groove.

In certain embodiments, each of the first filling groove and the second filling groove is concavely formed on a bottom surface of the insulating body, a baffle wall protrudes from a bottom of the insulating body and located between the first filling groove and the second filling groove, and a bottom surface of the baffle wall is lower than a bottom surface of the first sealing member.

In one embodiment, the bottom surface of the first sealing member is lower than a bottom surface of the second sealing member.

In certain embodiments, each of the first terminals has a first soldering portion extending from the first connecting portion and passing through a bottom surface of the insulating body, each of the second terminals has a second soldering portion extending from the second connecting portion and passing through the bottom surface of the insulating body, and the plurality of first soldering portions and the plurality of second soldering portions are arranged respectively in a front row and a back row.

In certain embodiments, the insulating body includes an upper insulator, a lower insulator and a plastic block; the plurality of first terminals and the lower insulator are integrally formed; the plurality of second terminals and the upper insulator are integrally formed; the upper insulator and the lower insulator are assembled and then integrally formed with the plastic block by injection molding; and the first filling groove communicates with an assembly gap between the upper insulator and the lower insulator.

In one embodiment, the second filling groove is a gap between the upper insulator and the plastic block.

In certain embodiments, a shielding sheet is clamped between the upper insulator and the lower insulator; at least one side of the shielding sheet is provided with a first retaining portion and a second retaining portion spaced from each other; the first retaining portion is formed by bending upwards and extending from the at least one side of the shielding sheet to retain a top surface of the upper insulator; and the second retaining portion is formed by bending downwards and extending from the at least one side of the shielding sheet to retain a bottom surface of the lower insulator.

In certain embodiments, the groove is concavely formed inwards on an external surface of the insulating body, and the groove is annular; and the first sealing member comprises a first waterproof ring formed in the groove by glue dispensing and a waterproof board is formed in the first filling groove by glue dispensing.

In certain embodiments, the insulating body has a base and a docking portion extending forward from the base; the groove is connected to the base and the docking portion; the base is located outside the metal shell; a slot is formed between a front end of the base and a rear end of the metal shell; and the first sealing member further comprises a second waterproof ring located between the first waterproof ring and the waterproof board, and the second waterproof ring is formed in the slot by glue dispensing.

In certain embodiments, the front end of the base has a front end surface, each of two opposite sides of the base has a side surface respectively, a chamfer surface is formed between the side surfaces and the front end surface and surrounds the base, and the slot is located between the chamfer surface and the rear end of the metal shell.

In certain embodiments, the rear end of the metal shell has a back wall, a chamfer surface is formed between the back wall and side walls of the metal shell and surrounds a periphery of the back wall, and the slot is located between the chamfer surface and the front end of the base.

In certain embodiments, each of the first terminals further has a first contact portion extending forward from the first connecting portion and exposed on a bottom surface of the docking portion; each of the second terminals has a second contact portion extending forward from the second connecting portion and exposed on a top surface of the docking portion; each of the plurality of first contact portions corresponds one-to-one to one of the plurality of second contact portions; and the plurality of first connecting portions and the plurality of second connecting portions are arranged in two rows and are respectively fixed on the base.

Compared with the art, the electrical connector according to certain embodiments of the present invention has the following beneficial effects: the insulating body is provided with the first filling groove that communicates with the groove, each first connecting portion is located partially in the first filling groove, and the first sealing member is filled in the first filling groove and extends to fill the groove. Thus, as long as glue is dispensed only in the first filling groove, the first filling groove and the groove can be filled without adding other glue dispensing inlets to dispense glue in the groove, thereby simplifying the manufacturing process. Moreover, the insulating body is concavely provided with the second filling groove that is spaced from the first filling groove, and the second sealing member is filled in the second filling groove alone to seal the second connecting portions, thus reducing the usage of glue and preventing unnecessary waste, and thereby reducing the manufacturing cost of the electrical connector.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a three-dimensional exploded view of an electrical connector according to one embodiment of the present invention.

FIG. 2 is a schematic view of a first sealing member, a second sealing member and an insulating body of the electrical connector being disassembled according to one embodiment of the present invention.

FIG. 3 is a schematic view of the first sealing member and second sealing member being formed on the insulating body of the electrical connector in FIG. 2 by glue dispensing.

FIG. 4 is a schematic view of FIG. 3 from another angle.

FIG. 5 is a bottom view of the electrical connector according to one embodiment of the present invention.

FIG. 6 is a bottom view of the first sealing member and second sealing member being formed on the insulating body of the electrical connector by glue dispensing according to one embodiment of the present invention.

FIG. 7 is a sectional view of the electrical connector in FIG. 5 along a line A-A.

FIG. 8 is an enlarged view of part H in FIG. 7.

FIG. 9 is a schematic view of the electrical connector being assembled and not provided with the first sealing member and second sealing member according to one embodiment of the present invention.

FIG. 10 is a sectional view of the electrical connector according to a further embodiment of the present invention.

FIG. 11 is an enlarged view of part I in FIG. 10.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

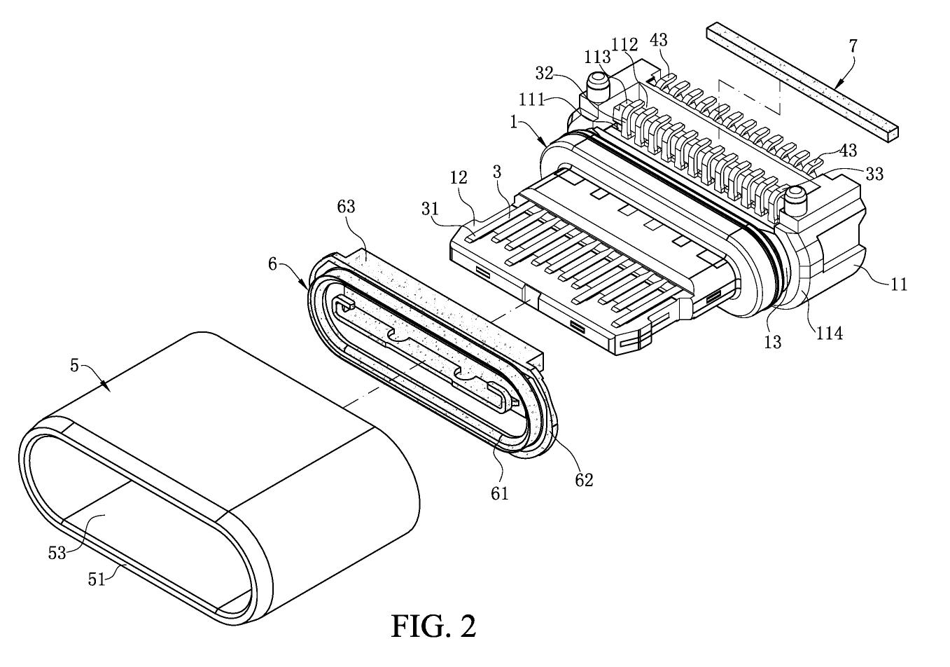

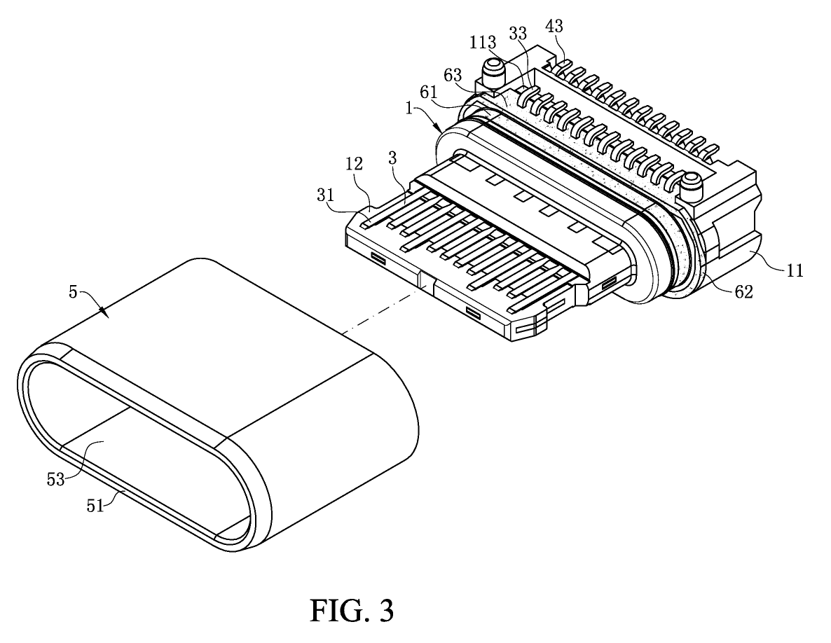

It should be noted that some of the drawings are schematic views from different angles. For example, FIG. 2 is a schematic view of a first sealing member, a second sealing member and an insulating body of the electrical connector being disassembled according to one embodiment of the present invention, in which the electrical connector is turned over in an upside-down position. Similarly, FIG. 3 is a schematic view of the first sealing member and second sealing member being formed on the insulating body of the electrical connector by glue dispensing according to one embodiment of the present invention, in which the electrical connector is turned over in an upside-down position. In other words, for all the components as shown in FIG. 2 and FIG. 3, a “lower side” refers to the side shown on the top of the drawings in FIG. 2 and FIG. 3.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

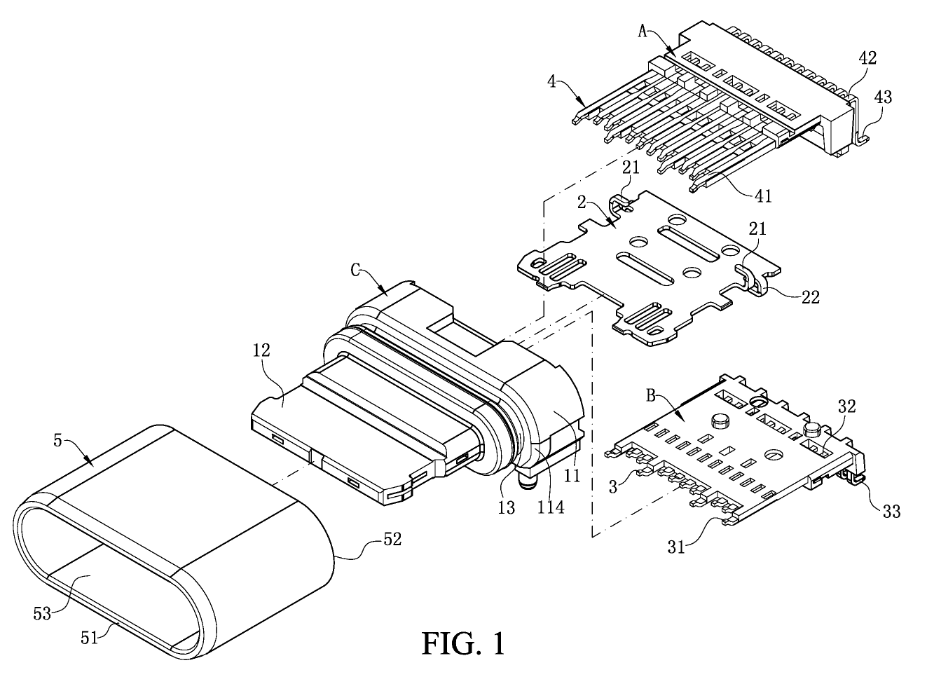

The description will be made as to the embodiments of the present invention in conjunction with the accompanying drawings in FIGS. 1-8. In accordance with the purposes of this invention, as embodied and broadly described herein, this invention, in one aspect, relates to an electrical connector.

As shown in FIG. 1, FIG. 2 and FIG. 3, an electrical connector includes an insulating body 1, a plurality of first terminals 3 and a plurality of second terminals 4 accommodated in the insulating body 1, a shielding sheet 2 installed on the insulating body 1, a metal shell 5 wrapping a periphery of the insulating body 1, and a first sealing member 6 and a second sealing member 7 formed on the insulating body 1 by glue dispensing to seal a rear end of the electrical connector. The front end of the electrical connector is configured for docking with a docking connector (not shown in the drawings), and the rear end of the electrical connector is configured to be soldered onto a circuit board (not shown in the drawings).

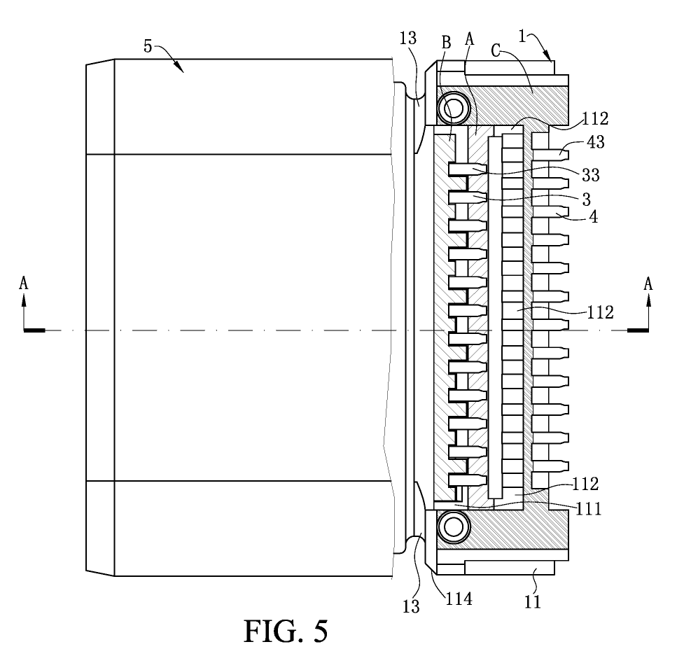

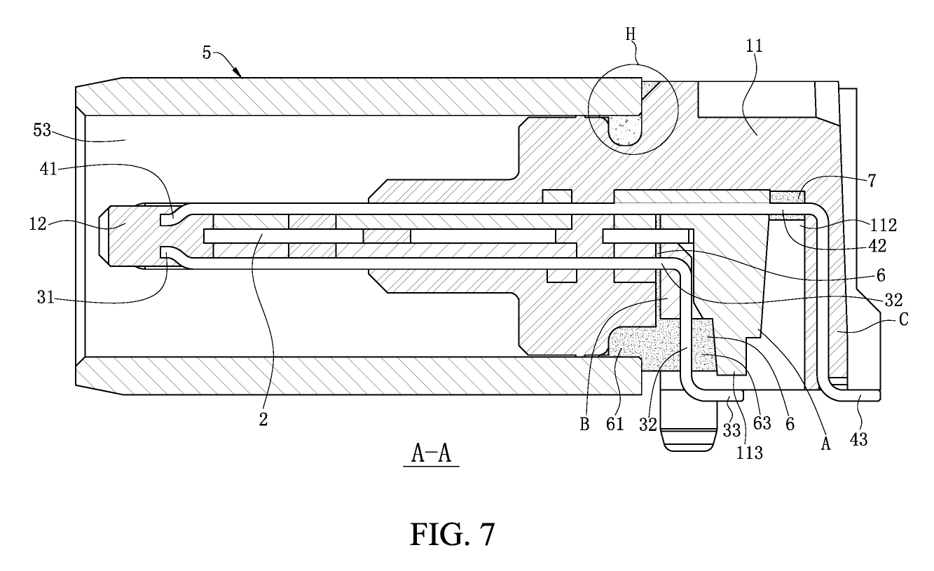

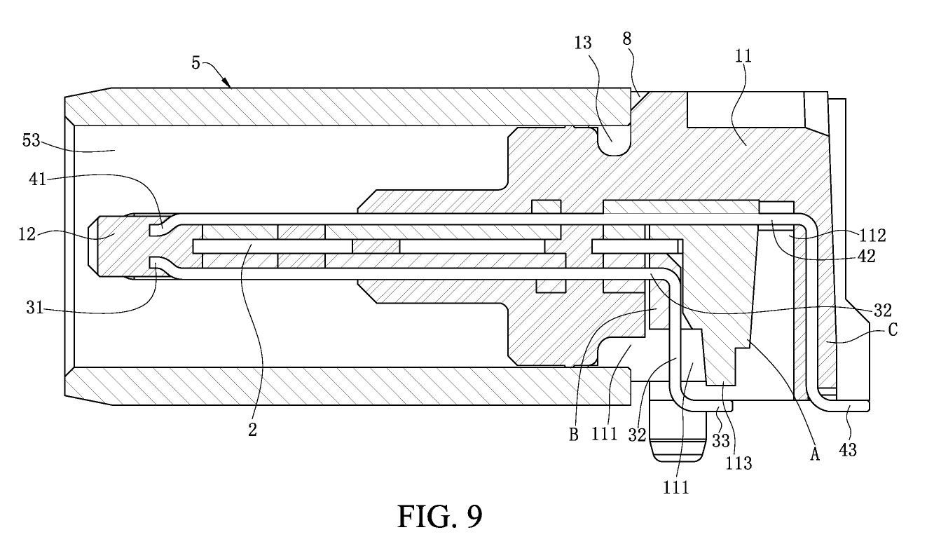

As shown in FIG. 2, FIG. 5 and FIG. 7, the insulating body 1 has a base 11 and a docking portion 12 extending forward from the base 11. The docking portion 12 is located in the metal shell 5, and the base 11 is located outside the metal shell 5. The insulating body 1 is concavely provided with a groove 13, which is concavely formed inwards on an external surface of the insulating body 1, and the groove 13 is annular. That is, the groove 13 surrounds a periphery of the insulating body 1. The groove 13 is connected to the base 11 and the docking portion 12, and the groove 13 is located between the insulating body 1 and the metal shell 5. The insulating body 1 is further provided with a first filling groove 111 that communicates with the groove 13. That is, the first filling groove 111 is concavely formed on the insulating body 1 near the groove 13. The insulating body 1 is further concavely provided with a second filling groove 112 that is spaced from the first filling groove 111, and the second filling groove 112 is strip-shaped. Each of the first filling groove 111 and the second filling groove 112 is concavely formed on a bottom surface of the insulating body 1. That is, the first filling groove 111 communicates with a lower side (i.e., the upper side as shown in FIG. 2) of the groove 13. A baffle wall 113 is provided to protrude from a bottom of the insulating body 1, and is located between the first filling groove 111 and the second filling groove 112. A bottom surface of the baffle wall 113 is lower than a bottom surface of the first sealing member 6, and the baffle wall 113 partitions the first filling groove 111 from the second filling groove 112, so that the first filling groove 111 and the second filling groove 112 do not communicate with each other. In the present embodiment, both the first filling groove 111 and the second filling groove 112 are located on the bottom surface (i.e., the surface facing upwards as shown in FIG. 2) of the base 11. As shown in FIG. 9, a slot 8 is arranged between the front end of the base 11 and the rear end of the metal shell 5, the front end of the base 11 has a front end surface (not numbered), each of the two opposite sides of the base 11 has a side surface (not numbered) respectively, and a chamfer surface 114 is formed between the side surfaces and the front end surface. The chamfer surface 114 surrounds the base 11, and is located outside the metal shell 5. The slot 8 is located between the chamfer surface 114 and the rear end of the metal shell 5.

As shown in FIG. 1, FIG. 5 and FIG. 7, the insulating body 1 includes an upper insulator A, a lower insulator B, and a plastic block C. The plurality of first terminals 3 and the lower insulator B are integrally formed, and the plurality of second terminals 4 and the upper insulator A are integrally formed. The upper insulator A and the lower insulator B are assembled and then integrally formed with the plastic block C by injection molding. The first filling groove 111 communicates with an assembly gap between the upper insulator A and the lower insulator B, and the second filling groove 112 is a gap between the upper insulator A and the plastic block C.

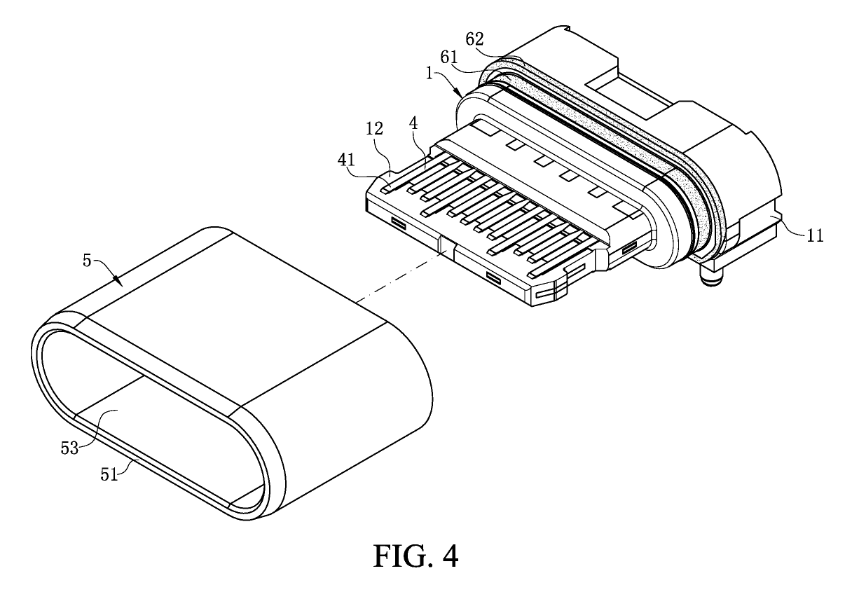

As shown in FIG. 1, FIG. 4 and FIG. 7, the shielding sheet 2 is clamped between the upper insulator A and the lower insulator B, and is integrally formed along with the upper insulator A, the lower insulator B and the plastic block C by injection molding. At least one side of the shielding sheet 2 is provided with a first retaining portion 21 and a second retaining portion 22 spaced from each other. In the present embodiment, both sides of the shielding sheet 2 are provided with the first retaining portions 21 and the second retaining portions 22. In other embodiments, the first retaining portion 21 and the second retaining portion 22 may be arranged on only one side of the shielding sheet 2. Both the first retaining portions 21 and the second retaining portions 22 are integrally formed by bending and extending from the shielding sheet 2, and the extending directions are opposite. Specifically, each first retaining portion 21 is formed by bending upwards and extending from one side of the shielding sheet 2 to retain a top surface of the upper insulator A, thereby fixing the upper insulator A; and each second retaining portion 22 is formed by bending downwards and extending from one side of the shielding sheet 2 to retain a bottom surface of the lower insulator B, thereby fixing the lower insulator B. The upper insulator A and the lower insulator B are fixed firmly by the first retaining portions 21 and the second retaining portions 22, thereby preventing the upper insulator A and the lower insulator B from sliding relatively to affect the formation of the plastic block C.

As shown in FIG. 1, FIG. 3 and FIG. 5, each first terminal 3 is provided with a first connecting portion 32, which is fixed on the base 11 and located partially in the first filling groove 111. The first connecting portions 32 are arranged in a row. Each second terminal 4 is provided with a second connecting portion 42, which is fixed on the base 11 and located partially in the second filling groove 112. The second connecting portions 42 are arranged in another row. Each first terminal 3 further has a first contact portion 31, which extends forward from the first connecting portion 32 and is exposed on the bottom surface of the docking portion 12. Each second terminal 4 further has a second contact portion 41, which extends forward from the second connecting portion 42 and is exposed on the top surface of the docking portion 12. There are twelve first terminals 3 and twelve second terminals 4 that are respectively distributed symmetrically along the center of the docking portion 12. The first contact portions 31 and the second contact portions 41 are correspondingly arranged one-to-one vertically, thereby ensuring that the first contact portions 31 and the second contact portions 41 of the electrical connector can be electrically connected with correct alignments with the corresponding contact portions of the docking connector, regardless of whether the docking connector is inserted upside down or not. Each first terminal 3 further has a first soldering portion 33 that extends from the first connecting portion 32 and passes through the bottom surface of the insulating body 1, and the first soldering portions 33 are arranged in a row. Each second terminal 4 further has a second soldering portion 43 that extends from the second connecting portion 42 and passes through the bottom surface of the insulating body 1, and the second soldering portions 43 are arranged in a row.

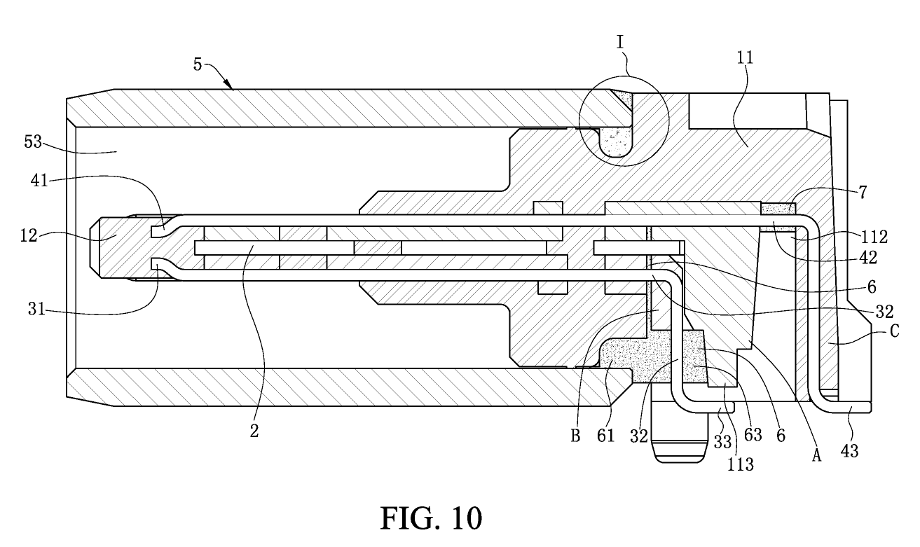

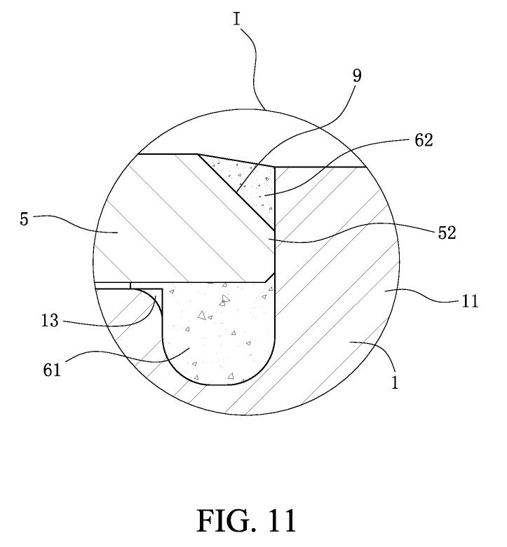

As shown in FIG. 1, FIG. 2 and FIG. 5, the metal shell 5 is formed by a tube, so an external wall surface of the metal shell 5 does not have any gaps and holes, thereby providing good sealing. A front end of the metal shell 5 is provided with a front wall 51, and a rear end of the metal shell 5 is provided with a back wall 52. Each of the front wall 51 and the back wall 52 is provided with an opening (not numbered), and the metal shell 5 has an accommodating cavity 53 connected to the two openings. The accommodating cavity 53 is used to accommodate the docking portion 12. The base 11 is located on the back side of the back wall 52. The back wall 52 is flush with the rear end of the groove 13. In the present embodiment, the base 11 is provided with the chamfer surface 114. In another embodiment, as shown in FIG. 10 and FIG. 11, the base 11 is not provided with the chamfer surface 114, and the rear end of the metal shell 5 is provided with the chamfer surface 9. That is, a chamfer surface 9 is formed between the back wall 52 and the side walls of the metal shell 5, the chamfer surface 9 surrounds a periphery of the back wall 52, and the slot 8 is located between the chamfer surface 9 and the front end of the base 11. In other embodiments, both the base 11 and the back wall 52 of the metal shell 5 are provided with the chamfer surfaces 114 and 9, as long as it is ensured that the slot 8 is formed between the front end of the base 11 and the rear end of the metal shell 5.

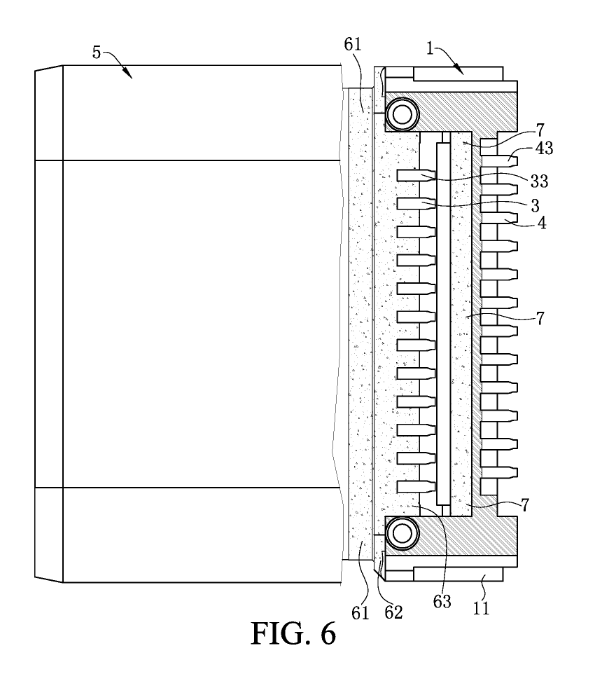

As shown in FIG. 2, FIG. 4 and FIG. 6, the first sealing member 6 is filled in the first filling groove 111 by glue dispensing, and extends to fill in the groove 13, thus sealing the gap between the insulating body 1 and the metal shell 5 as well as the first connecting portions 32. The second sealing member 7 is filled in the second filling groove 112 by glue dispensing to seal the second connecting portions 42. The first sealing member 6 and the second sealing member 7 can be made of a material with a high sealing and waterproof effect, such as glue or liquid rubber. Glue is used in the present embodiment. The first sealing member 6 and the second sealing member 7 can prevent liquid substances, such as water, from infiltrating therein from the rear end of the electrical connector. Since the first sealing member 6 is filled in the first filling groove 111 by glue dispensing and extends to fill in the groove 13, glue may be dispensed only in the first filling groove 111 to fill both the first filling groove 111 and the groove 13 without adding other glue dispensing inlets to dispense glue in the groove 13, thereby simplifying the manufacturing process. Moreover, the insulating body 1 is concavely provided with the second filling groove 112 that is spaced from the first filling groove 111, and the second sealing member 7 is filled in the second filling groove 112 alone to seal the second connecting portions 42, thus reducing the usage of glue and preventing unnecessary waste, and thereby reducing the manufacturing cost of the electrical connector. Since the first filling groove 111 communicates with the assembly gap between the upper insulator A and the lower insulator B, the first sealing member 6 is filled in the assembly gap between the upper insulator A and the lower insulator B while being filled in the first filling groove 111. Thus, moisture cannot get in the space between the upper insulator A and the lower insulator B, thereby further protecting the first terminals 3 and the second terminals 4 from the moisture. The second filling groove 112 is a gap between the upper insulator A and the plastic block C. In other words, the second sealing member 7 seals the upper insulator A and the plastic block C when being filled in the second filling groove 112, thus enhancing the waterproof effect of the electrical connector.

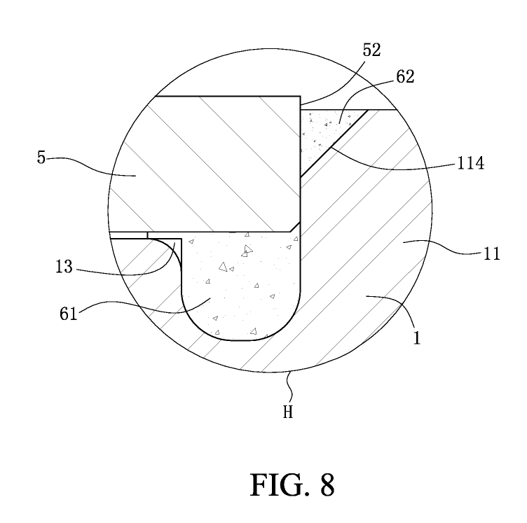

As shown in FIG. 2, FIG. 3 and FIG. 7, the first sealing member 6 includes a first waterproof ring 61 formed in the groove 13 by glue dispensing and a waterproof board 63 formed in the first filling groove 111 by glue dispensing. The first waterproof ring 61 is located in the groove 13 and partially protrudes out of the groove 13 to seal the gap between the insulating body 1 and the metal shell 5, and the waterproof board 63 is located in the first filling groove 111 to seal a space around the first connecting portions 32. The bottom surface of the baffle wall 113 is lower than the bottom surface of the waterproof board 63. That is, the thickness of the waterproof board 63 is less than the thickness of the baffle wall 113, thus reducing the usage of glue under the premise of ensuring the sealing of the first connecting portions 32, and preventing from over-dispensing too much glue that may flow beyond the baffle wall 113 to get into the second filling groove 112, thereby further saving glue. As shown in FIG. 8, the first sealing member 6 also includes a second waterproof ring 62 that is located between the first waterproof ring 61 and the waterproof board 63. The second waterproof ring 62 is formed in the slot 8, and the diameter of the second waterproof ring 62 is greater than the diameter of the first waterproof ring 61. The second waterproof ring 62 is connected to the first waterproof ring 61 and the waterproof board 63. The first waterproof ring 61 is located in the metal shell 5 to seal the gap between the internal wall surface of the metal shell 5 and the external surface of the insulating body 1. That is, the first waterproof ring 61 seals the interior of the metal shell 5. The second waterproof ring 62 is located outside the metal shell 5 to seal an opening of the external rear end of the metal shell 5, thus preventing moisture outside the metal shell 5 from entering the metal shell 5. That is, the second waterproof ring 62 seals the exterior of the metal shell 5, thereby enhancing the sealing of the electrical connector.

As shown in FIG. 2, FIG. 6 and FIG. 7, the second sealing member 7 is formed in the second filling groove 112 by glue dispensing to seal a space around the second connecting portions 42. Since the second filling groove 112 is strip-shaped and the second connecting portions 42 are arranged in a row, the second sealing member 7 is correspondingly strip-shaped. Moreover, the bottom surface of the second sealing member 7 is far higher than the bottom surface of the insulating body 1. That is, the thickness of the second sealing member 7 is small, thus resulting in little usage of glue for forming the second sealing member 7, and thereby reducing the cost.

As shown in FIG. 1, FIG. 6 and FIG. 7, during assembly, the plurality of first terminals 3 and the lower insulator B are first integrally formed, and the plurality of second terminals 4 and the upper insulator A are integrally formed. Then, the upper insulator A and the lower insulator B are assembled together along a vertical direction, and the shielding sheet 2 is clamped between the upper insulator A and the lower insulator B. The first retaining portions 21 retain the top surface of the upper insulator A, so that the upper insulator A is fixed, and the second retaining portions 22 retain the bottom surface of the lower insulator B, so that the lower insulator B is fixed. The plastic block C is then formed on the peripheries of the upper insulator A and the lower insulator B by injection molding, thus forming the insulating body 1. Finally, the metal shell 5 sleeves the periphery of the insulating body 1 with the base 11 located outside the metal shell 5. During glue dispensing, glue is first dispensed in the first filling groove 111 for the first time, so that the glue flows to the groove 13, the slot 8 and the assembly gap between the upper insulator A and the plastic block C while filling in the first filling groove 111, thus forming the first sealing member 6 after the glue is solidified. Glue is then dispensed for the second time, so that the glue fills in the second filling groove 112 to form the second sealing member 7 after the glue is solidified, thereby completing the work of glue dispensing.

To sum up, in certain embodiments, the electrical connector of the present invention has the following beneficial effects:

(1) The first sealing member 6 is filled in the first filling groove 111 by glue dispensing and extends to fill in the groove 13, thus sealing the gap between the insulating body 1 and the metal shell 5 as well as the first connecting portions 32. The second sealing member 7 is filled in the second filling groove 112 by glue dispensing to seal the second connecting portions 42. Thus, glue may be dispensed only in the first filling groove 111 to fill both the first filling groove 111 and the groove 13 without adding other glue dispensing inlets to dispense glue in the groove 13, thereby simplifying the manufacturing process. Moreover, the insulating body 1 is concavely provided with the second filling groove 112 that is spaced from the first filling groove 111, and the second sealing member 7 is filled in the second filling groove 112 alone to seal the second connecting portions 42, thus reducing the usage of glue and preventing unnecessary waste, and thereby reducing the manufacturing cost of the electrical connector.

(2) The first waterproof ring 61 is located in the groove 13 and partially protrudes out of the groove 13 to seal the gap between the insulating body 1 and the metal shell 5, and the waterproof board 63 is located in the first filling groove 111 to seal a space around the first connecting portions 32. The bottom surface of the baffle wall 113 is lower than the bottom surface of the waterproof board 63. That is, the thickness of the waterproof board 63 is less than the thickness of the baffle wall 113, thus reducing the usage of glue under the premise of ensuring the sealing of the first connecting portions 32, and preventing from over-dispensing too much glue that may flow beyond the baffle wall 113 to get into the second filling groove 112, thereby further saving glue.

(3) The second waterproof ring 62 is formed in the slot 8, and the diameter of the second waterproof ring 62 is greater than the diameter of the first waterproof ring 61. The second waterproof ring 62 is connected to the first waterproof ring 61 and the waterproof board 63. The first waterproof ring 61 is located in the metal shell 5 to seal the gap between the internal wall surface of the metal shell 5 and the external surface of the insulating body 1. That is, the first waterproof ring 61 seals the interior of the metal shell 5. The second waterproof ring 62 is located outside the metal shell 5 to seal an opening of the external rear end of the metal shell 5, thus preventing moisture outside the metal shell 5 from entering the metal shell 5. That is, the second waterproof ring 62 seals the exterior of the metal shell 5, thereby enhancing the sealing of the electrical connector.

(4) Since the second filling groove 112 is strip-shaped and the second connecting portions 42 are arranged in a row, the second sealing member 7 is correspondingly strip-shaped. Moreover, the bottom surface of the second sealing member 7 is far higher than the bottom surface of the insulating body 1. That is, the thickness of the second sealing member 7 is small, thus resulting in little usage of glue for forming the second sealing member 7, and thereby reducing the cost.

(5) Since the first filling groove 111 communicates with the assembly gap between the upper insulator A and the lower insulator B, the first sealing member 6 is filled in the assembly gap between the upper insulator A and the lower insulator B while being filled in the first filling groove 111. Thus, moisture cannot get in the space between the upper insulator A and the lower insulator B, thereby further protecting the first terminals 3 and the second terminals 4 from the moisture.

(6) The second filling groove 112 is a gap between the upper insulator A and the plastic block C. In other words, the second sealing member 7 seals the upper insulator A and the plastic block C when being filled in the second filling groove 112, thus enhancing the waterproof effect of the electrical connector.

(7) Each first retaining portion 21 is formed by bending upwards and extending from one side of the shielding sheet 2 to retain a top surface of the upper insulator A, thereby fixing the upper insulator A; and each second retaining portion 22 is formed by bending downwards and extending from one side of the shielding sheet 2 to retain a bottom surface of the lower insulator B, thereby fixing the lower insulator B. The upper insulator A and the lower insulator B are fixed firmly by the first retaining portions 21 and the second retaining portions 22, thereby preventing the upper insulator A and the lower insulator B from sliding relatively to affect the formation of the plastic block C.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body, concavely provided with a groove, a first filling groove communicating with the groove, and a second filling groove spaced from the first filling groove;
a plurality of first terminals and a plurality of second terminals, accommodated in the insulating body, wherein each of the first terminals has a first connecting portion located partially in the first filling groove, and each of the second terminals has a second connecting portion located partially in the second filling groove;
a metal shell, wrapping a periphery of the insulating body, wherein the groove is located between the insulating body and the metal shell;
a first sealing member, filled in the first filling groove and extending to fill in the groove; and
a second sealing member, filled in the second filling groove.

2. The electrical connector according to claim 1, wherein each of the first filling groove and the second filling groove is concavely formed on a bottom surface of the insulating body, a baffle wall protrudes from a bottom of the insulating body and located between the first filling groove and the second filling groove, and a bottom surface of the baffle wall is lower than a bottom surface of the first sealing member.

3. The electrical connector according to claim 2, wherein the bottom surface of the first sealing member is lower than a bottom surface of the second sealing member.

4. The electrical connector according to claim 1, wherein each of the first terminals has a first soldering portion extending from the first connecting portion and passing through a bottom surface of the insulating body, each of the second terminals has a second soldering portion extending from the second connecting portion and passing through the bottom surface of the insulating body, and the plurality of first soldering portions and the plurality of second soldering portions are arranged respectively in a front row and a back row.

5. The electrical connector according to claim 1, wherein:
the insulating body comprises an upper insulator, a lower insulator and a plastic block;
the plurality of first terminals and the lower insulator are integrally formed;
the plurality of second terminals and the upper insulator are integrally formed;
the upper insulator and the lower insulator are assembled and then integrally formed with the plastic block by injection molding; and
the first filling groove communicates with an assembly gap between the upper insulator and the lower insulator.

6. The electrical connector according to claim 5, wherein the second filling groove is a gap between the upper insulator and the plastic block.

7. The electrical connector according to claim 5, wherein:
a shielding sheet is clamped between the upper insulator and the lower insulator;
at least one side of the shielding sheet is provided with a first retaining portion and a second retaining portion spaced from each other;
the first retaining portion is formed by bending upwards and extending from the at least one side of the shielding sheet to retain a top surface of the upper insulator; and
the second retaining portion is formed by bending downwards and extending from the at least one side of the shielding sheet to retain a bottom surface of the lower insulator.

8. The electrical connector according to claim 1, wherein:
the groove is concavely formed inwards on an external surface of the insulating body, and the groove is annular; and
the first sealing member comprises a first waterproof ring formed in the groove by glue dispensing and a waterproof board is formed in the first filling groove by glue dispensing.

9. The electrical connector according to claim 8, wherein:
the insulating body has a base and a docking portion extending forward from the base;
the groove is connected to the base and the docking portion;
the base is located outside the metal shell;
a slot is formed between a front end of the base and a rear end of the metal shell; and
the first sealing member further comprises a second waterproof ring located between the first waterproof ring and the waterproof board, and the second waterproof ring is formed in the slot by glue dispensing.

10. The electrical connector according to claim 9, wherein the front end of the base has a front end surface, each of two opposite sides of the base has a side surface respectively, a chamfer surface is formed between the side surfaces and the front end surface and surrounds the base, and the slot is located between the chamfer surface and the rear end of the metal shell.

11. The electrical connector according to claim 9, wherein the rear end of the metal shell has a back wall, a chamfer surface is formed between the back wall and side walls of the metal shell and surrounds a periphery of the back wall, and the slot is located between the chamfer surface and the front end of the base.

12. The electrical connector according to claim 9, wherein:
each of the first terminals has a first contact portion extending forward from the first connecting portion and exposed on a bottom surface of the docking portion;
each of the second terminals has a second contact portion extending forward from the second connecting portion and exposed on a top surface of the docking portion;
each of the plurality of first contact portions corresponds one-to-one to one of the plurality of second contact portions; and
the plurality of first connecting portions and the plurality of second connecting portions are arranged in two rows and are respectively fixed on the base.
